(19) United States
(12) Patent Application Publication
(10) Pub. No.: US 2025/0062059 A1
(43) Pub. Date: Feb. 20, 2025

(54) ACTUATION ASSEMBLY AND ACTUATOR FOR A POWER TRAIN

(71) Applicant: VALEO EMBRAYAGES, Amiens (FR)

(72) Inventors: Xavier HAUVETTE, Cergy Pontoise (FR); Eric RUMEAU, Cergy Pontoise (FR); Glauber Assis ARAUJO DE ARRUDA, Cergy Pontoise (FR); Roël VERHOOG, Cergy Pontoise (FR); Alexis DOUCET, Cergy Pontoise (FR); Mathieu GAMBULA, Limoges (FR); Thibault VENANT, Cergy Pontoise (FR)

(73) Assignee: VALEO EMBRAYAGES, Amiens (FR)

(21) Appl. No.: 18/724,056

(22) PCT Filed: Dec. 22, 2022
(86) PCT No.: PCT/EP2022/087417

§ 371 Date: Jun. 25, 2024

(30) Foreign Application Priority Data
Dec. 29, 2021 (FR) 2114629

(51) Int. Cl. H01F 7/16; F16D 27/09; F16D 27/14; F16D 127/02; H01F 7/08

(52) U.S. Cl. CPC H01F 7/16; H01F 7/081; H01F 7/088; F16D 27/09; F16D 27/14; F16D 2127/02; F16D 2300/14; F16D 2500/1022; F16D 2500/10412; F16D 2500/10462

(57) ABSTRACT

An electromagnetic actuation assembly includes an actuator comprising a magnetic field frame provided with an annular housing extending circumferentially about a reference axis, a coil arranged in the annular housing of the magnetic field frame, and a plunger able to be moved axially between a first axial zone and a second axial zone with respect to the magnetic field frame as a function of the magnetic field produced by the coil when this coil is supplied with current. A first shock absorber is mounted either on the plunger or on the magnetic field frame or on an actuator support to which the actuator is fixed, the first shock absorber being arranged in such a way as to be deformed by the movement of the plunger when the plunger reaches the first axial zone.

### TECHNICAL FIELD

The invention relates to the field of electromagnetic actuation assemblies, particularly the field of electromagnetic actuators, notably within the field of vehicle powertrains.

### TECHNOLOGICAL BACKGROUND

Document US2015114786 discloses a transmission system of the differential type. The transmission system comprises a differential casing, movable in rotation about an axis A, and which is equipped with a gear wheel driven by a power unit of the vehicle. Housed inside the casing there are a supporting ring guided in rotation in the casing, two planet pinions mounted with the ability to rotate on the supporting ring about an axis B perpendicular to the axis A, and two sun gears each of which meshes with the two planet pinions and each of which is secured, for conjoint rotation, to a half-shaft. Moreover, the transmission system comprises a coupling device that can be used either to couple the casing of the transmission system to the supporting ring so as to transmit and distribute the torque from the power unit to the two half-shafts of the axle, or to uncouple these so as to interrupt the transmission of torque between the power unit and the half-shafts. The coupling device is a claw coupling device. It comprises a first coupling part having an annular portion arranged on the outside of the casing, and projecting elements which extend from the annular portion and pass through orifices formed in the casing, thereby enabling the first coupling part and the casing to be secured against rotation. The projecting elements comprise toothsets which are intended to engage with complementary slots formed on the supporting ring. The first coupling part is axially mobile with respect to the casing between an uncoupled position and a coupled position in which the toothsets of the first coupling part engage with the slots of the supporting ring. An electromagnetic actuator is able to apply axial force to the first coupling part so as to move it from the uncoupled position to the coupled position. The actuator comprises a plunger which moves axially between first and second axial positions associated with the coupled and uncoupled positions of the claw coupling.

Such a transmission system is not entirely satisfactory.

In particular, when the plunger reaches the first and second axial positions, its movement is halted by an end-stop which generates noise.

### SUMMARY

One idea on which the invention is based is to propose an electromagnetic actuation assembly which is less noisy.

According to one embodiment, the invention provides an electromagnetic actuation assembly, comprising:
an actuator comprising a magnetic field frame provided with an annular housing extending circumferentially about a reference axis (X),
a coil arranged in the annular housing of the magnetic field frame, and a plunger able to be moved axially between a first axial zone and a second axial zone with respect to the magnetic field frame as a function of the magnetic field produced by the coil when this coil is supplied with current,
a first shock absorber mounted either on the plunger or on the magnetic field frame or on an actuator support to which the actuator is fixed, the first shock absorber (61) being arranged in such a way as to be deformed by the movement of the plunger (28) when the plunger reaches the first axial zone (Z1).

Because the first and second axial zones are zones occupied by the plunger when it reaches the end of its travel, the deformation of the first shock absorber allows the slowing of the plunger or the dissipation of the vibrations generated when the plunger reaches the end-of-travel zones. The first and second axial zones are associated with the retracted position (or passive position) of the plunger and with the extended position (or active position) of the plunger, or vice versa.

The shock absorbing assembly may also have one or more of the following features:

According to one embodiment, the first shock absorber is arranged in such a way as to slow the plunger before the plunger comes into contact with either the magnetic field frame or the actuator support as the plunger enters the first axial zone in the first axial direction.

As a preference, the coil is annular and centered on the reference axis.

As a preference, the magnetic field frame and the plunger are configured in such a way that the plunger is able to slide axially in the magnetic field frame.

As a preference, the shapes of the magnetic field frame and of the plunger provide a slideway association in the axial direction.

According to one embodiment, the electromagnetic actuation assembly comprises a spring, and the electromagnetic actuation assembly is configured in such a way that when the coil is electrically powered, notably beyond a first threshold current strength, the plunger moves, against the action of an elastic return force exerted axially by the spring, toward an active position corresponding to one of either the first axial zone and the second axial zone, the elastic return force being able to return the plunger to a passive position corresponding to the other of either the first axial zone and the second axial zone when the coil is no longer electrically powered, or is powered with current below the first threshold strength.

According to one embodiment, the first axial zone occupied by the plunger corresponds to the active position of the plunger and the actuation assembly is configured in such a way that, when the plunger moves into the first axial zone in the first axial direction, the first shock absorber deforms between a first plunger position in which the first shock absorber begins to be axially compressed, directly or indirectly, between the plunger and the magnetic field frame or between the plunger and the actuator support, and a second plunger position in which the plunger and the magnetic field frame, or the plunger and the actuator support, are pressed rigidly against one another, the pressure being between a first abutment surface of the plunger, on the one hand, and a second abutment surface of the magnetic field frame or of the actuator support, on the other hand, the abutment surface of the plunger on the one hand and the abutment surface of the magnetic field frame or of the actuator support on the other hand, being spaced away from one another when the plunger is in the first position of the first axial zone.

Advantageously, the first abutment surface is metal and magnetic and the second abutment surface is metal and magnetic. Thus, adhesion through a magnetization effect may be obtained and the coil current strength can be reduced in the active position.

According to a variant, the first axial zone occupied by the plunger corresponds to the passive position of the plunger.

According to one embodiment, the first shock absorber is made completely or partially from an elastomer material, such as rubber, for example a hydrogenated nitrile rubber (HNBR).

According to a variant, the first shock absorber is an elastic washer such as a Belleville spring washer.

According to one embodiment, the first shock absorber is arranged in such a way as to be compressed between the plunger and the magnetic field frame of the actuator.

According to one embodiment, the first shock absorber is borne by the plunger.

According to one embodiment, the first shock absorber is arranged in such a way as to press against a bearing surface of the magnetic field frame or of the actuator support when the plunger is in the first axial zone.

According to one embodiment, the first shock absorber is borne by the magnetic field frame or the actuator support.

As a preference, the plunger, the magnetic field frame or the actuator support comprises a recess the shape of which compliments that of the first shock absorber, the first shock absorber being housed partly in the recess.

In particular, the magnetic field frame comprises a casing defining the annular housing and a magnetic cap partially closing the casing, the recess being formed on a radially internal portion of the magnetic cap.

Advantageously, the plunger comprises a shoulder separating an interior portion of the plunger from an exterior part that is able to exit the actuator. The contact between the plunger and the magnetic field frame or the actuator support is via this shoulder.

According to one embodiment, the first shock absorber is mounted directly on the magnetic field frame.

According to one embodiment, the first shock absorber is arranged in such a way as to press against a surface of the plunger when the plunger is in the first axial zone.

According to one embodiment, the first shock absorber comprises a ring arranged around the reference axis X and radial tabs, the ends of the tabs being intended to be in contact with the plunger when the plunger enters the first axial zone.

According to one embodiment, the radial tabs extend radially inward from the ring.

As a preference, the electromagnetic actuation assembly comprises at least one cutout intended to accommodate some of the material of the first shock absorber, which material is displaced as the shock absorber deforms.

As a preference, the electromagnetic actuation assembly comprises a second shock absorber, the second shock absorber being able to deform in order to limit the noise generated by contact between the plunger and either the magnetic field frame or the actuator support in the second axial zone.

According to one embodiment, the second shock absorber is able to deform in order to slow the plunger when the plunger enters the second axial zone in a second axial direction that is the opposite of the first axial direction.

According to a variant, the second axial zone occupied by the plunger corresponds to the passive position of the plunger.

According to one embodiment, the actuation assembly is configured in such a way that, when the plunger moves into the second axial zone in the second axial direction, the second shock absorber deforms between a third plunger position in which the second shock absorber begins to be axially compressed, directly or indirectly, between the plunger and the magnetic field frame or between the plunger and the actuator support, and a fourth plunger position in which the plunger and the magnetic field frame, or the plunger and the actuator support are pressed rigidly against one another.

According to one embodiment, the first shock absorber is arranged in such a way as to dissipate the vibrations generated by contact between the plunger and either the magnetic field frame or the actuator support.

According to one embodiment, the first shock absorber comprises an axial stack of metal, for example sheet metal, laminations.

According to one embodiment, the magnetic field frame comprises a casing defining the annular housing and a magnetic cap partially closing the casing, the magnetic cap of the magnetic field frame being formed, at least in part, by this stack of metal laminations.

According to one embodiment, the laminations may be stacked directly upon one another so that the vibrations of the shock between the magnetic field frame and the plunger are dissipated by shearing between the sheet metal laminations.

According to one embodiment, the first shock absorber comprises at least one layer of soundproofing material interposed between two metal laminations.

This soundproofing material may be a polymer or an elastomer.

According to one embodiment, the magnetic cap is formed by two metal laminations between which a layer of soundproofing material extends.

As a preference, the first shock absorber is formed on a distinct part of the coil or of the overmolding that envelops the coil.

The above features relating to the first shock absorber may also be applied to the second shock absorber.

The invention also relates to a transmission system for a vehicle powertrain, notably an electric powertrain, the transmission system comprising an input shaft and an output shaft, the transmission system comprising an electromagnetic actuation assembly as described hereinabove, the electromagnetic actuation assembly being able to disengage a first coupling part from a second coupling part, for example of a claw coupling device, so as to interrupt the transmission of torque between the input shaft and the output shaft.

### BRIEF DESCRIPTION OF THE FIGURES

The invention will be better understood, and other aims, details, features and advantages thereof will become more clearly apparent, from the following description of several particular embodiments of the invention, given solely by way of illustration and without limitation, with reference to the appended drawings.

FIG. 1 is a schematic diagram of the electromagnetic actuation assembly according to a first embodiment.

FIG. 2 is a schematic diagram of the first shock absorber of FIG. 1.

FIG. 3 is a schematic cross-sectional view of a transmission system comprising an actuation assembly according to a third embodiment.

FIG. 4 is an exploded perspective view showing the cap and the first shock absorber of the third embodiment.

FIG. 5 is a perspective view of part of the cap of the third embodiment.

FIG. 6 is a perspective view of the plunger and of the second shock absorber of the third embodiment, the view being an exploded view on the right and depicting the assembled state on the left.

FIG. 7 is a cross-sectional view of detail of the plunger and of the second shock absorber of the third embodiment.

FIG. 8 is a schematic view of a fourth embodiment.

FIG. 9 is a schematic view of a fifth embodiment.

FIG. 10 is a schematic view of a sixth embodiment.

FIG. 11 is a schematic view of a seventh embodiment.

FIG. 12 is a schematic view of an eighth embodiment.

FIG. 13 is a schematic view of a ninth embodiment.

### DESCRIPTION OF THE EMBODIMENTS

In the description and the claims, the terms “external” and “internal” and the orientations “axial” and “radial” will be used to denote elements of the transmission system according to the definitions given in the description. By convention, the “radial” orientation is directed orthogonally to the reference axis X which determines the “axial” orientation. The “circumferential” orientation is directed orthogonally to the axis X and orthogonally to the radial direction.

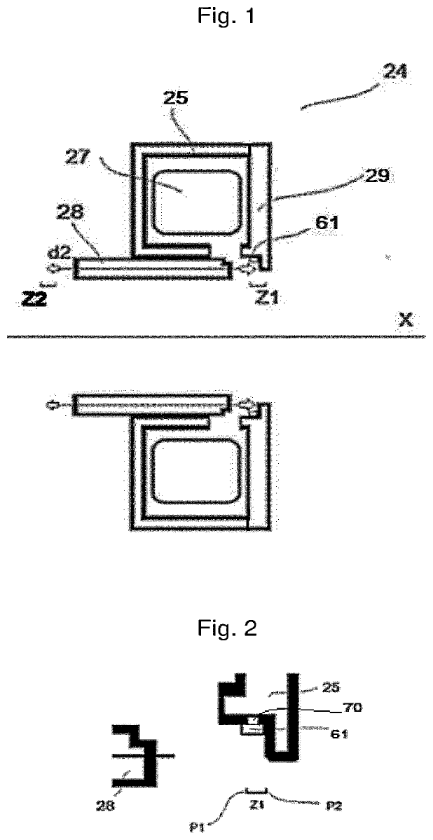

FIGS. 1 and 2 schematically illustrate the invention. FIG. 1 shows an actuator 24 comprising a magnetic field frame 25 provided with an annular housing extending circumferentially about a reference axis X, a coil 27 arranged in the annular housing of the magnetic field frame, and a plunger 28 able to be moved axially between a first axial zone Z1 and a second axial zone Z2 with respect to the magnetic field frame 25 as a function of the magnetic field produced by the coil when this is supplied with current.

A first shock absorber 61 mounted on the magnetic field frame is able to deform in order to slow the plunger 28 as the latter enters the first axial zone Z1 in a first axial direction d1.

The first shock absorber 61 may have a shape that is annular about the reference axis X. A cutout 70, such as a groove, may be formed near the first shock absorber, notably on the bearing surface of the first shock absorber so as to accommodate the material of the first shock absorber as the first shock absorber deforms.

The invention is not restricted to a shock absorber arranged on the magnetic field frame but also covers other variants in which the first shock absorber is arranged on the plunger or on an actuator support to which the actuator is fixed.

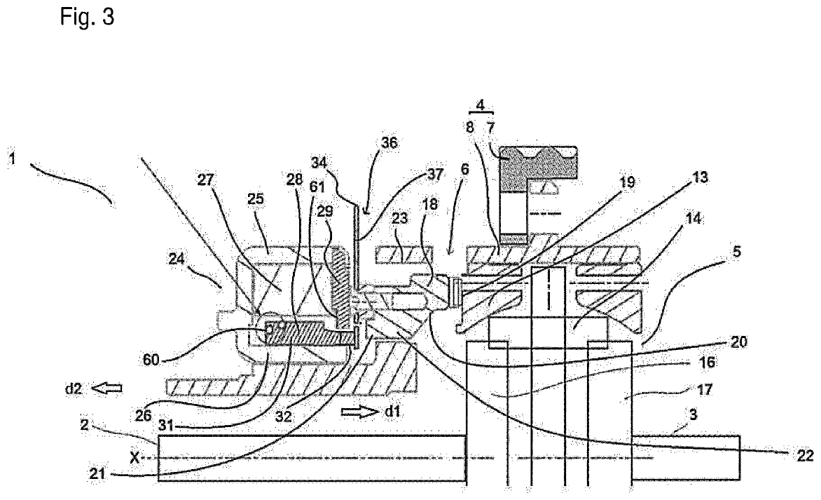

FIG. 3 partially illustrates a transmission system 1 having a first and a second shock absorber 61, 60. The transmission system here comprises a differential which is used in a vehicle drivetrain to transmit and distribute a torque originating from a power unit (not shown) towards two wheel half-shafts 2, 3 of a motor vehicle axle. Such a transmission system may, for example, form part of a secondary drivetrain capable of transmitting torque from a secondary power unit of the vehicle, such as an electric motor, to a rear or front axle of a vehicle, while a primary drivetrain is capable of transmitting torque from a main power unit, for example an internal combustion engine, to the half-shafts at the wheels of another axle of the vehicle. According to other embodiments which have not been illustrated, the transmission system may also take some form other than that of a differential.

The transmission system comprises a first element 4 which is rotationally mobile about the axis X and intended to be driven by a power unit, such as an electric motor (not shown); a second element 5 which is likewise rotationally mobile about the axis X and intended to drive the half-shafts 2, 3 at the wheels; and a coupling device 6 able selectively to couple or decouple the first element 4 and the second element 5.

The first element 4 comprises a gear wheel 7 which is intended to be driven by the power unit via a reduction gearset, not shown. This first element 4 also comprises a casing 8 which is fixed for conjoint rotation to the gearwheel 7 by means of fasteners, not shown, such as nuts or bolts.

The second element 5 is depicted schematically in FIG. 3. It comprises a supporting ring 13 of annular shape, which is guided in rotation about the axis X inside the casing 8. For this purpose, the casing 8 has an inner cylindrical portion collaborating with a cylindrical outer surface of the supporting ring 13 in order to guide this in rotation relative to the casing 8. The second element 5 also comprises two planet pinions 14 which are mounted to rotate on the supporting ring 13 about an axis Z perpendicular to the axis X. The two planet pinions 14, 15 each have bevel gear teeth which mesh with complementary bevel gear teeth of two sun gears 16, 17. The two sun gears 16, 17 are rotationally mobile about the axis X and are each secured, for conjoint rotation, to one of the two half-shafts 2, 3. The supporting ring 13, the planet pinions 14, 15 and the sun gears 16, 17 form a differential allowing the two half-shafts 2, 3 to rotate at different speeds.

Also, the transmission system 1 comprises a coupling device 6 which, in the coupled position, allows a torque to be transmitted between the first element 4 and one of the elements of the second element 5, in this instance the supporting ring 13. Thus, when the coupling device 6 is in the coupled position, the transmission system allows torque to be transmitted between the power unit and the half-shafts 2, 3 at the wheels, while performing a differential function to allow the half-shafts 2, 3 to rotate at different speeds. However, in another embodiment which has not been depicted, the coupling device is configured to couple the first element 4 to one of the two sun gears 16, 17. This sun gear therefore has two sets of teeth, preferably axially back to back. One set engages with the planet pinions, and the other engages with the first coupling part. In such an embodiment, the supporting ring 13 is unable to rotate independently of the casing 8 and the coupling device therefore seeks to prevent the two half-shafts 2, 3 from rotating at different speeds (locks the differential).

Returning to the embodiment shown, it may be noted that the coupling device 6 comprises a first coupling part 18 which is rotationally fixed to the casing 8 while being movable axially along the axis X relative to said casing 8. The first coupling part 18 is able to move between an uncoupled position and a coupled position. In the uncoupled position, the first coupling part 18 is uncoupled from a second coupling part 19 which is rotationally fixed to the supporting ring 13, so that the transmission of torque between the casing 8 and the supporting ring 13 is interrupted. By contrast, in the coupled position, the first coupling part 18 is coupled to the second coupling part 19, and this allows the transmission of torque between the casing 8 and the supporting ring 13.

In the embodiment depicted, the coupling device 6 is a claw-type coupling device. Thus one of the first and second coupling parts 18, 19 comprises teeth while the other comprises corresponding slots into which said teeth engage when the first coupling part 18 is in the coupled position. In the embodiment depicted, the second coupling part 19 is formed of one piece with the supporting ring 13. In other words, the teeth or slots are formed in the lateral face of the supporting ring 13 which face faces toward the first coupling part 18. However, although the invention has been described in connection with a claw-type coupling device, it is not restricted thereto, and the coupling device could be of another type and notably a friction coupling device.

As can be seen from FIG. 3, the first coupling part 18 comprises an interior portion 20 which is housed inside the casing 8, an exterior portion 21 which is positioned outside the casing 8, and connecting portions 22 which are evenly distributed about the axis X and each pass through a corresponding through-opening 23 formed in the casing 8, which allows the first coupling part 18 to be rotationally fixed to the casing 8 while allowing a relative axial movement between the first coupling part 18 and the casing 8. In the embodiment depicted, the interior portion 20 is annular whereas the exterior portion 21 comprises lugs extending axially in the continuation of the connecting portions 22. However, according to another embodiment variant, the structure is reversed and the exterior portion 21 is annular whereas the interior portion 20 comprises a plurality of axially oriented tabs extending in the continuation of the connecting portions 22.

The actuator 24 enables the first coupling part 18 to be moved axially. The actuator 24 comprises a magnetic field frame 25 which is intended to be mounted on a case, fixed to the chassis, of the vehicle drivetrain. The magnetic field frame 25 is thus fixed in terms of rotation relative to the reference axis X. It is fixed to its support by means of fasteners which have not been illustrated. The magnetic field frame 25 comprises an internal skirt 26 which comprises a cylindrical guide portion that collaborates with a corresponding cylindrical portion of the casing 8 and thus allows the casing 8 to rotate with respect to the fixed magnetic field frame 25 of the actuator 24.

The actuator 24 is an electromagnetic actuator. It comprises the magnetic field frame 25 which has an internal housing and a piston 28 able to move axially inside the internal housing between a retracted position and an extended position illustrated in FIG. 3. The magnetic field frame 25 comprises a casing defining the internal housing and a magnetic cap 29 which partially closes the internal housing and which comprises an end stop, to define the extended position of the piston 28 after the first shock absorber 61 has been compressed. The casing is U-shaped when observed in a plane containing the reference axis X. The piston 28 comprises a body 31, of annular shape, made of ferromagnetic material such as iron or steel for example. The piston 28 comes into abutment against the magnetic cap 29. The piston 28 further comprises a non-magnetic end piece 32, likewise of annular shape, which is fixed to the body 31 of the piston 28 and by means of which the actuating force is transmitted to the first coupling part 18. The non-magnetic end piece 32 of the piston 28 thus makes it possible to avoid undesirable magnetic flux leakage into the other components of the coupling device 6.

When the coil 27 is powered with a current stronger than a first threshold current, it allows the piston 28 to be moved from the retracted position to the extended position. When the piston 28 is in the extended position, the magnetic cap 29 exerts an attraction on the body 31 of the piston 28, enabling it to be held in the extended position. The strength of the current with which the coil 27 is powered can then be reduced so long as it remains above a second threshold current strength S2 which is lower than the first threshold current strength S1. When the coil 27 is not powered or is powered with a current lower than the threshold current strength, an elastic return means, in other words a spring, described hereinafter, which returns the first coupling part 18 toward the uncoupled position, is able to overcome the force of attraction between the magnetic cap 29 and the body 31 of the piston 28 and to return the piston 28 from the extended position to the retracted position.

Moreover, the coupling device 6 comprises a disk 36 that is formed as a single piece and is fixed axially to the first coupling part 18. The disk 36 has numerous functionalities described hereinbelow and thus helps to limit the cost, the complexity and the bulkiness of the coupling device 6.

First of all, the disk 36 acts as a target 34. For this purpose, the disk comprises an annular portion 37 formed at the radially external periphery of the disk 36. This annular portion 37 is positioned axially facing the sensor 35 and thus forms the target 34.

Moreover, the coupling device 6 comprises a contactless sensor, which is positioned axially facing the target 34 and which is configured to deliver a signal indicative of the axial distance between the target 34 and the sensor. Thus, the sensor is able to deliver a signal indicative of the position of the first coupling part 18, such a signal being used to ensure the reliability of the command issued to the coupling device 6 and notably to verify that the coupling device 6 is indeed in the uncoupled position or in the coupled position. The sensor is, for example, a Hall effect sensor.

Secondly, the disk 36 acts as an elastic return means to enable the first coupling part 18 to be returned toward the uncoupled position when the piston 28 of the actuator 24 returns to the retracted position. In order to do this, the disk 36 comprises elastic blades (not visible in the cross-sectional view of FIG. 3) each of which has a free end that presses against a bearing zone of the casing 8 and a proximal end connected to the rest of the disk 36. The elastic blades thus each form an elastic return portion which is configured to bend axially as the first coupling part 18 moves from the uncoupled position toward the coupled position. In reaction to this, the elastic blades apply a return force able to return said first coupling part 18 toward the uncoupled position.

Thirdly, the disk 36 is also able to transmit the actuating force between the piston 28 of the actuator 24 and the first coupling part 18.

The first shock absorber 61 mounted on the magnetic cap 29 of the magnetic field frame 25 is able to deform in order to slow the plunger 28 as the plunger 28 enters a first axial zone Z1 in the first axial direction d1, according to the schematic diagram of FIG. 1.

The first axial zone Z1 is an end-of-travel zone for the plunger 28 in which zone the travel of the plunger 28 is first slowed by the first shock absorber 61 and then halted by an end stop when the plunger 28 is in the extended position.

In order to limit noise when the piston 28 arrives in its retracted (or passive) position, a second shock absorber 60 is positioned on the plunger 28.

The second shock absorber 60 mounted on the plunger 28 is able to deform in order to slow the plunger 28 as the plunger 28 enters a second axial zone Z2 in the second axial direction d2.

The second axial zone Z2 is an end-of-travel zone for the plunger in which zone the travel of the plunger 28 is first slowed by the first shock absorber 60 and then halted by an end stop when the plunger is in the retracted position.

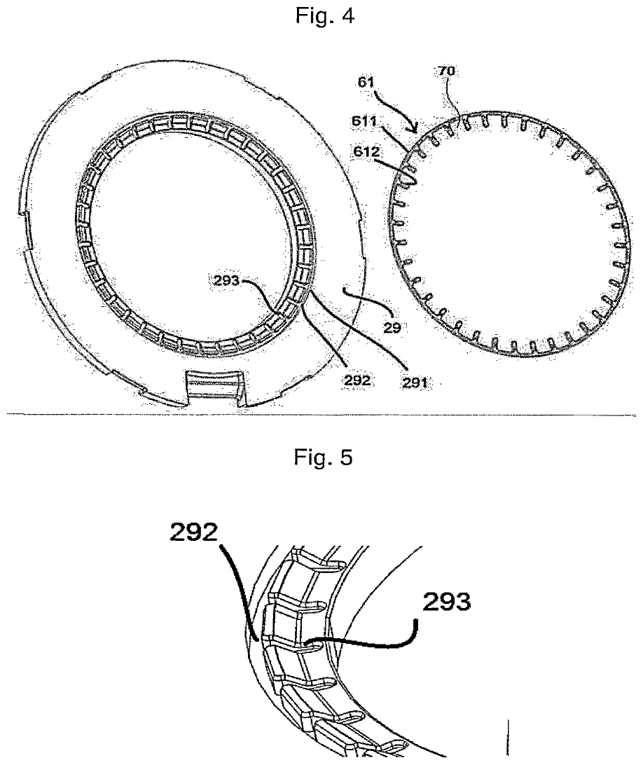

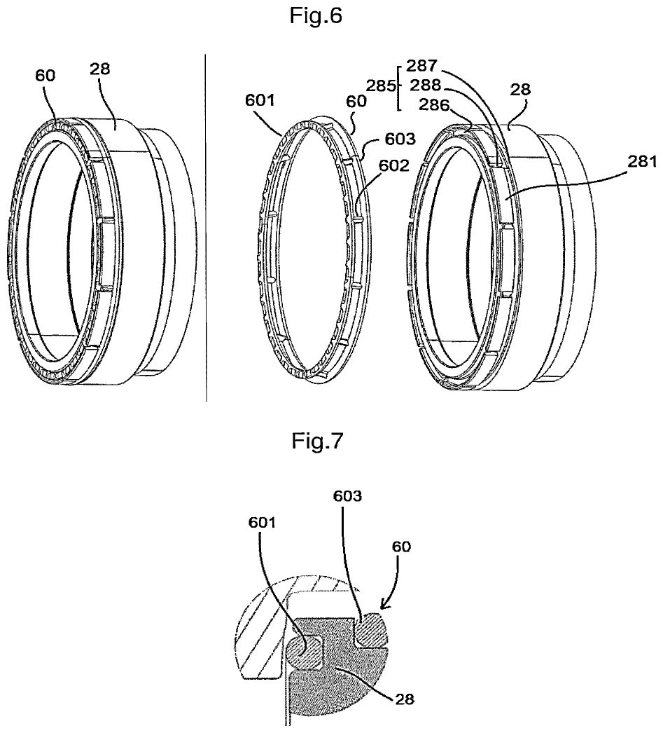

The details of the two shock absorbers are visible in FIGS. 4 to 7.

The first shock absorber 61 has an annular overall shape extending about the reference axis X. It comprises a ring 611 and radially extending lugs 612. The diameter of the ring 611 is greater than the outside diameter of that end of the plunger that faces toward the magnetic cap 29, and these lugs extend radially inward from the ring 611.

Only the lugs 611 are designed to come into contact with the plunger 28 and slow same. The ring 611 is used to join the shock-absorbing lugs 612 together and to center them about the reference axis X. The cutout 70 intended to accommodate the deformed material is present here circumferentially between the lugs 612.

The magnetic cap 29 on which the first shock absorber 61 is mounted comprises a recess 291 the shape of which compliments that of the first shock absorber 61. Thus, the first shock absorber can be held on the cap through the nesting of complementing shapes. Alternatively, or in addition, adhesive may be used to hold the first shock absorber 61 on its support. Alternatively, the first shock absorber may be overmolded on the cap 29.

The recess 291 comprises a circular slot 292 and a plurality of radial slots 293 each intended to accept a radial lug of the first shock absorber 61. The recess is positioned in the radially internal part of the magnetic cap.

Axially, the radially internal part of the magnetic cap is thinner so that the first shock absorber 61 projects axially from the magnetic cap 29. Thus, the plunger comes into contact with the first shock absorber 61 first of all, and then with the magnetic cap 29.

The second shock absorber 60 likewise has an annular overall shape extending about the reference axis X. It comprises a first ring 601 arranged on a rear face of the plunger 28. The plunger comprises radial teeth 281 arranged at the edge of the rear face and between which there extend fingers 602 of the second shock absorber 60.

A second ring 603 is arranged around the plunger 28 and is connected to the first ring 601 by the fingers 602.

The first ring 601 of the second shock absorber 60 is designed to come into contact with the magnetic field frame 25 and to slow the plunger 28.

The plunger 28 on which the second shock absorber 60 is mounted comprises a recess 285 the shape of which compliments that of the second shock absorber 60.

The recess 285 of the plunger comprises a first circular slot 286 arranged on the rear face of the plunger. The first circular slot 286 accepts the first ring 601. The recess of the plunger comprises a second circular slot 287 arranged on the external cylindrical surface of the plunger. The second circular slot 287 accepts the second ring 603.

The recess 285 of the plunger also comprises connecting slots 288 connecting the two circular slots.

Thus, the second shock absorber can be mounted rigidly on the plunger. The second shock absorber may be deformed in order to be mounted on the plunger or else may be overmolded onto the plunger.

If so desired, the plunger may equally be halted in its retracted position in two phases, namely a first contact between the magnetic field frame 25 and the second shock absorber 60 in a first phase, and a second contact between the magnetic field frame 25 and the plunger 28 in a second phase. The relative halting of the plunger 28 and of the magnetic field frame 25 may notably occur on the rear face of the radial teeth, as may be seen in FIG. 7.

In one alternative embodiment, this form of shock absorber may also replace the first shock absorber described hereinabove on the front part of the plunger 28 in order to slow the plunger in the extended position. Where applicable, the front part of the plunger 28 comprises a corresponding recess.

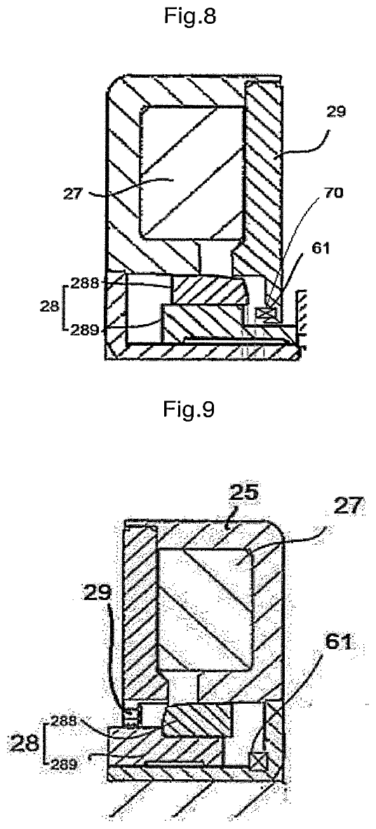

FIG. 8 schematically shows another embodiment in which the plunger 28 comprises two tubular parts 288 and 289. One of them, 288, is formed from a magnetic material. This part may be made to rotate axially by the magnetic field produced by the coil 27. The other of them, 289, is formed from a non-magnetic material. The two tubular parts are fixed rigidly one inside the other. Here, the plunger 28 is arranged radially inside the coil 27 and the non-magnetic part 289 is mounted radially on the inside of the magnetic part 288.

The first shock absorber 61 here is arranged axially facing the non-magnetic tubular part. The first shock absorber 61, as previously, is arranged on the radially internal part of the magnetic cap 29. It may have the shape of a ring arranged around the reference axis X. As a variant, it may be a plurality of shock absorbing pads arranged circumferentially around the reference axis X.

At the end of travel, the non-magnetic part 289 of the plunger 28 bears against the first shock absorber 61 and the plunger 28 is thus slowed before the magnetic tubular part 288 touches the magnetic cap 29 of the actuator.

In the case of an annular first shock absorber 61, this may be mounted in a circular slot the path of which allows it to accommodate some of the material of the first shock absorber when this shock absorber is deformed. For example, the slot may be flared, as may be seen in FIG. 8.

FIG. 9 schematically shows another embodiment in which the retracted position of the plunger involves shock absorption. To achieve this, the second shock absorber 60 is arranged inside the field frame of the actuator, on the rear wall of the field frame, so as to absorb the shock of the return of the plunger 28 to the retracted position.

At the end of travel, the non-magnetic part 289 of the plunger 28 bears against the second shock absorber 60 and the plunger 28 is thus slowed before the magnetic tubular part 288 touches the rear wall of the field frame.

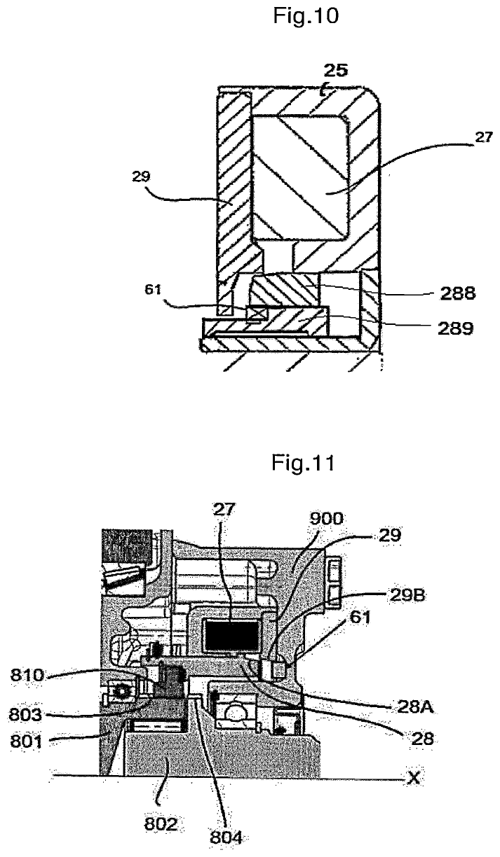

FIG. 10 schematically shows another embodiment in which the extended position of the plunger involves shock absorption. The first shock absorber 61 is arranged on the non-magnetic part 289 of the plunger 28. The first shock absorber 61 is positioned at the shoulder which, on the non-magnetic part of the plunger, separates that part of the plunger 28 that is intended to project from the actuator in the extended position from that part of the plunger that remains inside the magnetic field frame 25 irrespective of the position of the plunger and on which the magnetic part of the plunger is fixed. The cutout here takes the form of a groove formed on the non-magnetic part 289 of the plunger 28 and radially to the inside of the first shock absorber 61.

At the end of travel, the first shock absorber 61 comes into contact with the magnetic cap 29 before the magnetic part of the plunger 28 and the plunger 28 is thus slowed.

FIG. 11 schematically illustrates another embodiment. This is a transmission system in which a coupling device is configured to ensure or interrupt the transmission of torque between a hub 801 and a shaft 802. The coupling device comprises a sliding gear 810 which is in mesh with an exterior toothset 803 of the hub 801 and which is able also to enmesh with an exterior toothset 804 of the exterior shaft 802 in order to transmit torque between the hub 801 and the shaft 802. In order to do this, the sliding gear moves axially, driven toward the shaft 802 by the plunger 28 (pulled toward the right in FIG. 11). In this embodiment, the first shock absorber 61 is arranged on the support 900 on which the magnetic field frame 25 of the actuator 24 is mounted. In this instance here, this is part of a case 900 of a powertrain. The first shock absorber and the actuator together form an actuation assembly.

The first shock absorber 61 is designed to absorb the shock 28 of the plunger when the plunger reaches the first axial zone which here corresponds to the extended position of the plunger. Direct contact between the plunger 28 and the magnetic cap 29 is subsequently possible once the first shock absorber 61 has been deformed and the plunger 28 has continued its travel as far as the cap 29. The plunger 28 is then in abutment. An effect of magnetization between the plunger 28 and the magnetic cap 29 then allows the strength of the current in the coil 27 to be lowered while still keeping the plunger in the first axial zone. The current strength is then comprised between a second threshold S2, below which a spring returns the sliding gear to a disconnecting position, and the first current strength threshold S1.

The contact interface for contact between the plunger and the magnetic cap is advantageously frustaconical in shape with the tip of the cone facing in the first axial direction D1, namely in the direction followed by the plunger 28 in order to come into contact with the magnetic cap 29.

In this embodiment, the first shock absorber 61 may once again be made from an elastomer material such as rubber. It may have the shape of an annulus about the reference axis X or else may be made up of a plurality of pads distributed around the reference axis X. The first shock absorber may also take the form of an elastic washer such as a Belleville spring washer.

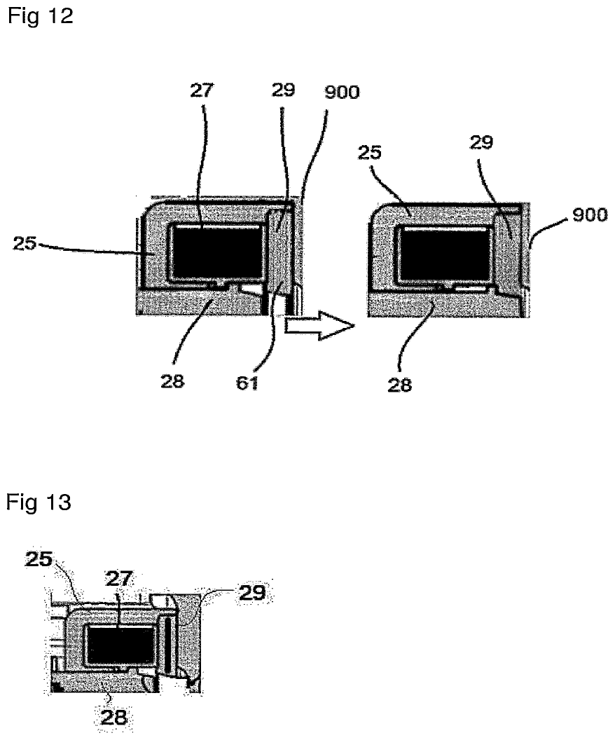

FIG. 12 schematically depicts another type of embodiment in which the vibrations of the shock of impact between the plunger 28 and the magnetic cap 29 are dissipated by the first shock absorber 61. The first shock absorber 61 here is integrated into the magnetic cap 29 of the magnetic field frame 25.

As previously, the magnetic field frame 25 comprises a casing defining the annular housing and a magnetic cap 29 partially closing the casing. The magnetic cap 29 is made up of an axial stack of metal, for example sheet metal, laminations that perform the shock absorbing function.

In the embodiment depicted, the laminations may be stacked directly upon one another so that the vibrations of the shock between the magnetic field frame 25 and the plunger 28 are dissipated by shearing between the sheet metal laminations, as depicted in FIG. 12. The deformation of the shock absorber occurs substantially at the same time as the contact between the plunger and the magnetic cap 29 of the magnetic field frame 25.

According to one embodiment, that lamination of the magnetic cap 29 that is furthest from the coil 27 is fixed to the casing, notably by welding, force-fitting or crimping. The other laminations, particularly at least those two laminations of the magnetic cap 29 that are closest to the coil 27, are held axially between a shoulder of the casing and the cap lamination furthest from the coil 27.

According to another embodiment, the first shock absorber may also comprise a layer of soundproofing material interposed between two metal laminations.

According to one embodiment, the magnetic cap 29 may be formed by two metal laminations between which a layer of soundproofing material extends (FIG. 13). This soundproofing material may be a polymer or an elastomer. This cap may for example be manufactured using a multi-layer material or a sandwich material marketed under the trade name Antiphon®.

Although the invention has been described in connection with a plurality of particular embodiments, it is obvious that it is in no way limited thereto and that it comprises all technical equivalents of the means described and combinations thereof where these fall within the scope of the invention as defined in the claims.

In the claims, any reference sign between parentheses should not be interpreted as limiting the claim.

1. An electromagnetic actuation assembly comprising:
an actuator comprising a magnetic field frame provided with an annular housing extending circumferentially about a reference axis, a coil arranged in the annular housing of the magnetic field frame, and a plunger able to be moved axially between a first axial zone and a second axial zone with respect to the magnetic field frame as a function of the magnetic field produced by the coil when this coil is supplied with current,
a first shock absorber mounted either on the plunger or on the magnetic field frame or on an actuator support to which the actuator is fixed, the first shock absorber being arranged in such a way as to be deformed by the movement of the plunger when the plunger reaches the first axial zone.

2. The electromagnetic actuation assembly as claimed in claim 1, wherein the first shock absorber is arranged in such a way as to slow the plunger before the plunger comes into contact with either the magnetic field frame or the actuator support as the plunger enters the first axial zone in the first axial direction.

3. The electromagnetic actuation assembly as claimed in claim 1, wherein the electromagnetic actuation assembly comprises a spring, and the electromagnetic actuation assembly is configured in such a way that when the coil is electrically powered, notably beyond a first threshold current strength, the plunger moves, against the action of an elastic return force exerted axially by the spring, toward an active position corresponding to one of either the first axial zone and the second axial zone, the elastic return force being able to return the plunger to a passive position corresponding to the other of either the first axial zone and the second axial zone when the coil is no longer electrically powered, or is powered with current below the first threshold strength;
and wherein the first axial zone occupied by the plunger corresponds to the active position of the plunger and the actuation assembly is configured in such a way that, when the plunger moves into the first axial zone in the first axial direction, the first shock absorber deforms between a first plunger position in which the first shock absorber begins to be axially compressed, directly or indirectly, between the plunger and the magnetic field frame or between the plunger and the actuator support, and a second plunger position in which the plunger and the magnetic field frame, or the plunger and the actuator support are pressed rigidly against one another, the pressure being between a first abutment surface of the plunger, on the one hand, and a second abutment surface of the magnetic field frame or of the actuator support, on the other hand, the abutment surface of the plunger on the one hand and the abutment surface of the magnetic field frame or of the actuator support on the other hand, being spaced away from one another when the plunger is in the first position of the first axial zone.

4. The electromagnetic actuation assembly as claimed in claim 1, wherein the first axial zone occupied by the plunger corresponds to the passive position of the plunger.

5. The electromagnetic actuation assembly as claimed in claim 1, wherein the first shock absorber is borne by the plunger.

6. The electromagnetic actuation assembly as claimed in claim 1, wherein the first shock absorber is borne by the magnetic field frame.

7. The electromagnetic actuation assembly as claimed in claim 1, wherein the first shock absorber is borne by the actuator support.

8. The electromagnetic actuation assembly as claimed in claim 1, wherein the first shock absorber is made completely or partially from an elastomer material.

9. The electromagnetic actuation assembly as claimed in claim 1, wherein the first shock absorber is an elastic washer.

10. The electromagnetic actuation assembly as claimed in claim 1, wherein the plunger, the magnetic field frame or the actuator support comprises a recess the shape of which compliments that of the first shock absorber, the first shock absorber being housed partly in the.

11. The electromagnetic actuation assembly as claimed in claim 10, wherein the magnetic field frame comprises a casing defining the annular housing and a magnetic cap partially closing the casing, the recess being formed on a radially internal portion of the magnetic cap.

12. The electromagnetic actuation assembly as claimed in claim 1, wherein the electromagnetic actuation assembly comprises at least one cutout intended to accommodate some of the material of the first shock absorber, which material is displaced as the shock absorber deforms.

13. The electromagnetic actuation assembly as claimed in claim 1, wherein the first shock absorber comprises a ring arranged around the reference axis and radial tabs, the ends of the tabs being intended to be in contact with the plunger when the plunger enters the first axial zone.

14. The electromagnetic actuation assembly as claimed in claim 1, wherein the electromagnetic actuation assembly comprises a second shock absorber, the second shock absorber being able to deform in order to limit the noise generated by contact between the plunger and either the magnetic field frame or the actuator support in the second axial zone.

15. The electromagnetic actuation assembly as claimed in claim 1, wherein the first shock absorber is arranged in such a way as to dissipate the vibrations generated by contact between the plunger and either the magnetic field frame or the actuator support.

16. The electromagnetic actuation assembly as claimed in claim 15, wherein the first shock absorber comprises an axial stack of metal, for example sheet metal, laminations.

17. The electromagnetic actuation assembly as claimed in claim 16, wherein the magnetic field frame comprises a casing defining the annular housing and a magnetic cap partially closing the casing, the magnetic cap of the magnetic field frame being formed, at least in part, by this stack of metal laminations.

18. The electromagnetic actuation assembly as claimed in claim 17, wherein the first shock absorber comprises at least one layer of soundproofing material interposed between two metal laminations.

19. The electromagnetic actuation assembly as claimed in claim 2, wherein the electromagnetic actuation assembly comprises a spring, and the electromagnetic actuation assembly is configured in such a way that when the coil is electrically powered, notably beyond a first threshold current strength, the plunger moves, against the action of an elastic return force exerted axially by the spring, toward an active position corresponding to one of either the first axial zone and the second axial zone, the elastic return force being able to return the plunger to a passive position corresponding to the other of either the first axial zone and the second axial zone when the coil is no longer electrically powered, or is powered with current below the first threshold strength;
and wherein the first axial zone occupied by the plunger corresponds to the active position of the plunger and the actuation assembly is configured in such a way that, when the plunger moves into the first axial zone in the first axial direction, the first shock absorber deforms between a first plunger position in which the first shock absorber begins to be axially compressed, directly or indirectly, between the plunger and the magnetic field frame or between the plunger and the actuator support, and a second plunger position in which the plunger and the magnetic field frame, or the plunger and the actuator support are pressed rigidly against one another, the pressure being between a first abutment surface of the plunger, on the one hand, and a second abutment surface of the magnetic field frame or of the actuator support, on the other hand, the abutment surface of the plunger on the one hand and the abutment surface of the magnetic field frame or of the actuator support on the other hand, being spaced away from one another when the plunger is in the first position of the first axial zone.

20. The electromagnetic actuation assembly as claimed in claim 2, wherein the first axial zone occupied by the plunger corresponds to the passive position of the plunger.
